(19) United States
(12) Patent Application Publication
(10) Pub. No.: US 2002/0144250 A1
(43) Pub. Date: Oct. 3, 2002

(54) System and method for updating an executing application software in a module manner

(75) Inventor: Hsiang Tsun Yen, Taipei (TW)

Correspondence Address: BACON & THOMAS, PLLC, 625 SLATERS LANE, FOURTH FLOOR, ALEXANDRIA, VA, 22314

(73) Assignee: Acermsoft Inc., Taipei Hsien (TW)

(21) Appl. No.: 09/938,602

(22) Filed: Aug. 27, 2001

(30) Foreign Application Priority Data
Mar. 28, 2001 (TW) 090107319

(51) Int. Cl. G06F 9/455

(52) U.S. Cl. 717/168

(57) ABSTRACT

A client executes a first application and raises a request. Accordingly, server sends a second configuration file. Client performs following steps: (a) receiving second configuration file; (b) determining whether versions of second and first application are the same, executing first application if yes, going to (c) if no; (c) determining whether second module of second application is updated, going to (d) if yes, going to (e) if no; (d) determining whether any unprocessed second module exists, going to (c) if yes, going to (f) if no; (e) connecting storage device for downloading and storing second module, and going to (d); (f) first module duplicating second module to second location; (g) first module stored in first location starting first module stored in second location; (h) ending first module stored in first location; and (i) first module duplicating second module to first location.

### REFERENCE TO RELATED APPLICATION

The present application claims priority to Taiwan application No.090107319, entitled “System and Method for Updating an Executing Application Software in a Module Manner,” filed on Mar. 28, 2001.

### BACKGROUND OF THE INVENTION

(1) Field of the Invention

The invention relates to a system and a method for updating an executing application software, and more particularly to the system and the method which utilize a module manner to update the executing application software.

(2) Description of the Prior Art

In a conventional system, while the system intends to update an application software, execution of the application software is firstly terminated and then a new (new-version) application software can replace the old one. After the replacement, the new application software can then be started.

In a client-server network system, new application software is usually stored in a server of the network to ease the downloading of the new application software at client computers for updating the application software. Hence, while the application software in the server is updated or altered, the server needs to inform all client computers of the existence of the new-version application software. On the other hand, while the user at the client computer end decides to update his/her application software, the first thing that the user needs to do is to terminate the execution of old application software, so that the client computer can be connected to a specific storage device in the network system for further downloading the new-version application software. At the client computer end, the downloaded application software is stored at the location used to store the old application software; i.e., the old application software is replaced by the new-version application software. Then, the new-version application software should be restarted before any execution.

In the art, it is obvious that the user needs to terminate the executing application software if he/she wants to process any updating upon the application software. Also, the new-version application software can only be used by restarting after the replacement or the updating. Therefore, in the conventional system, the executing application software is always interrupted before any replacing or updating.

In addition, in the art, the client computer always downloads a complete package of the new-version application software to replace the old one. It is known that the application software may include a plurality of function modules. However, for the new-version application software, it is not implied that all the function modules for the application software are updated. Therefore, while downloading the new-version application software, it is safe to download all the function modules at the same time, even though some function modules may not be updated. Apparently, downloading those un-changed function modules is tedious and will affect the efficiency of updating the application software.

### SUMMARY OF THE INVENTION

Accordingly, it is a primary object of the present invention to provide a system and a method for updating an executing application software in a module manner.

In accordance with the present invention, firstly, a client computer executes a first application software and raises a request to a server. Thereafter, the server accepts the request and sends out accordingly a second type file to the client computer. Then, the client computer performs following steps: (a) the first application software receiving the second type file from the server; (b) utilizing the second type file, the first application software determining whether or not the version of the second application software stored in a storage device is the same as that of the first application software, keeping executing the first application software if yes, and going to step (c) if no; (c) the first application software determining whether or not the second function module of the second application software is updated, going to step (d) if yes, and going to step (e) if no; (d) the first application software determining whether or not any unprocessed second function module exists, going to step (c) for determining whether the next second function module is updated if yes, and going to step (f) if no; (e) utilizing the second type file, the first application software connecting the storage device storing the second function module for downloading and storing the second function module, and then going to step (d); (f) the first function module stored in the first storage location duplicating the second function module respective to the first function module stored in the second storage location to the second storage location for replacing the respective first function module; (g) the first function module stored in the first storage location starting the first function module stored in the second storage location; (h) ending the first function module stored in the first storage location; and (i) the first function module stored in the second storage location duplicating the second function module respective to the first function module stored in the first storage location to the first storage location for replacing the respective first function module.

Provided by the present invention, while updating the application software, it is not required for a user of the client computer to terminate the execution of the old application software. After the application software is updated in accordance with the present invention, the client computer can keep executing the new-version application software. Hence, in the present invention, a before-hand termination upon the executing application software for an updating is no more necessary. It is to say that, upon updating the application software in accordance with the present invention, both stopping the old application software and restarting the new-version application software are not required.

Furthermore, while the application software is updated, the client computer can only download those updated function modules in the new-version application software and preserve those unchanged function modules, so that the efficiency of updating the application software can be increased.

These and other objectives of the present invention will no doubt become obvious to those of ordinary skill in the art after having read the following detailed description of the preferred embodiment, which is illustrated in the various figures and drawings.

### BRIEF DESCRIPTION OF THE DRAWINGS

The present invention will now be specified with reference to its preferred embodiment illustrated in the drawings, in which:

FIG. 1 is a schematic view of a preferred system in accordance with the present invention;

FIG. 2a is a flowchart of a preferred method in accordance with the present invention;

FIG. 2b is a flowchart of a preferred method in accordance with the present invention;

FIG. 3 is a schematic view of a first configuration file of the system in accordance with the present invention;

FIG. 4 is a schematic view of a second configuration file of the system in accordance with the present invention;

FIG. 5 is a schematic view of a first application software of the system in accordance with the present invention; and

FIG. 6 is a schematic view of a second application software of the system in accordance with the present invention.

### DESCRIPTION OF THE PREFERRED EMBODIMENT

The invention disclosed herein is directed to a system and a method for updating an executing application software in a module manner. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

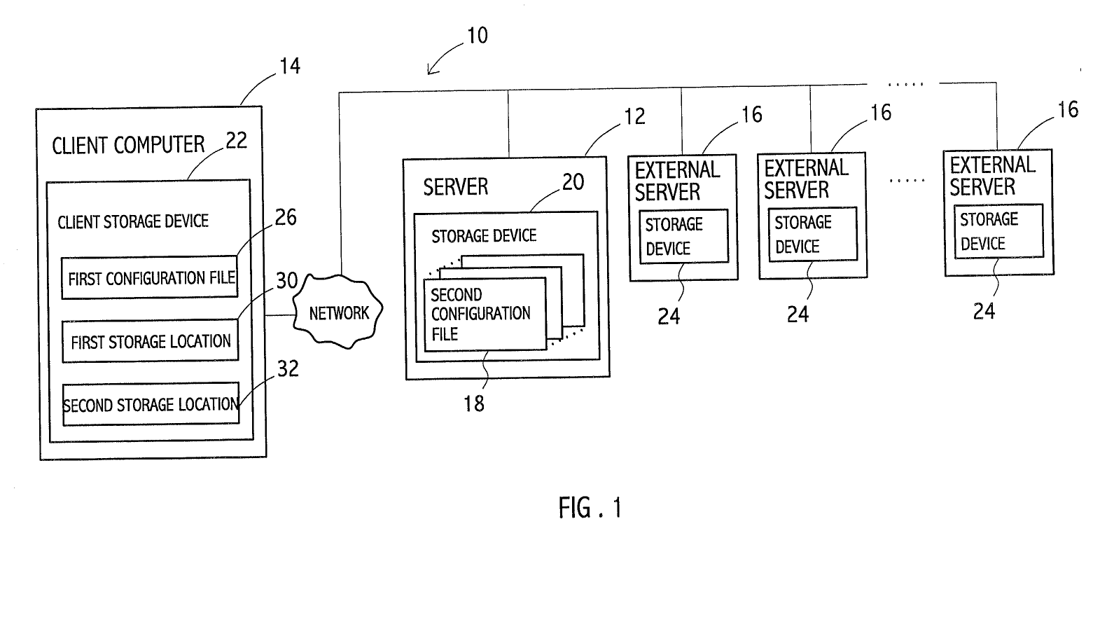

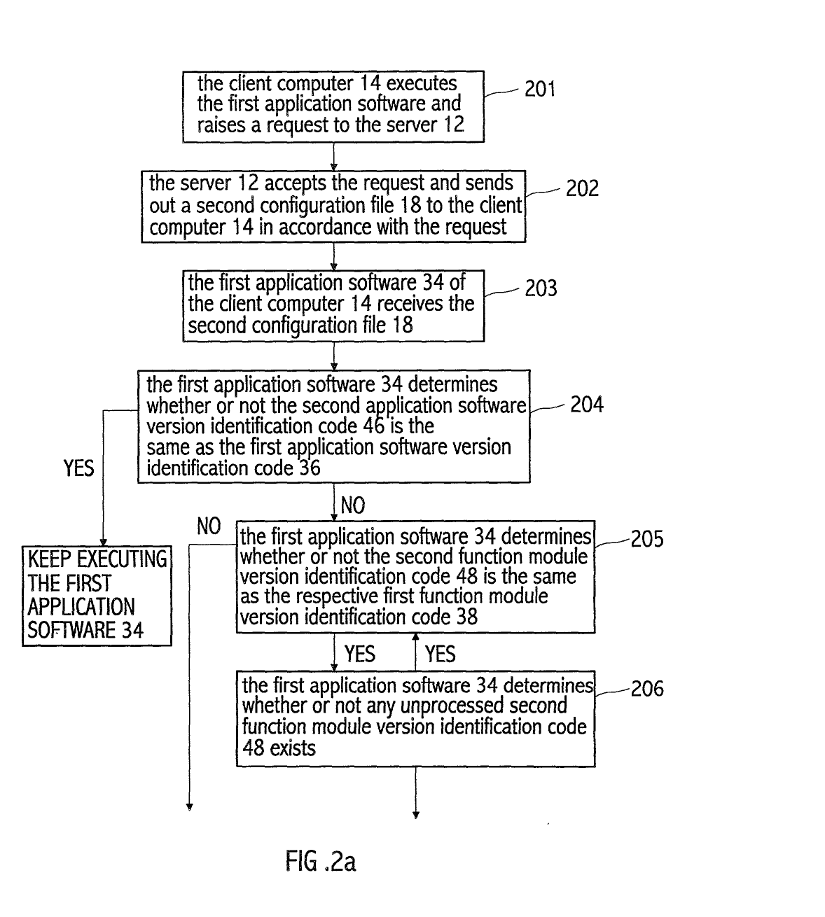

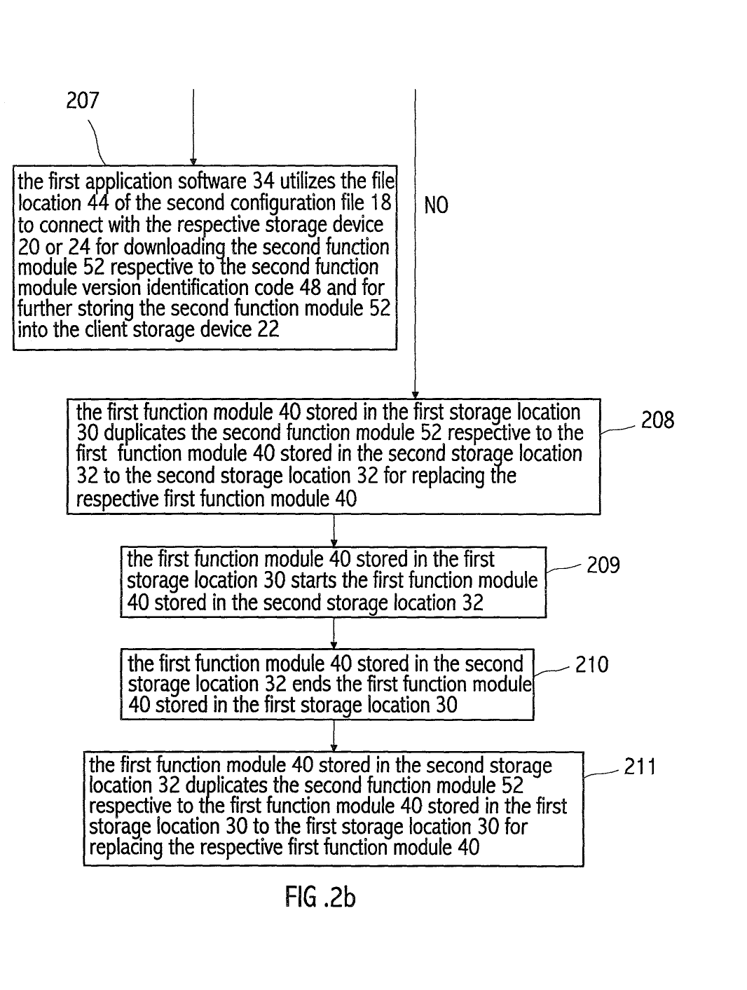

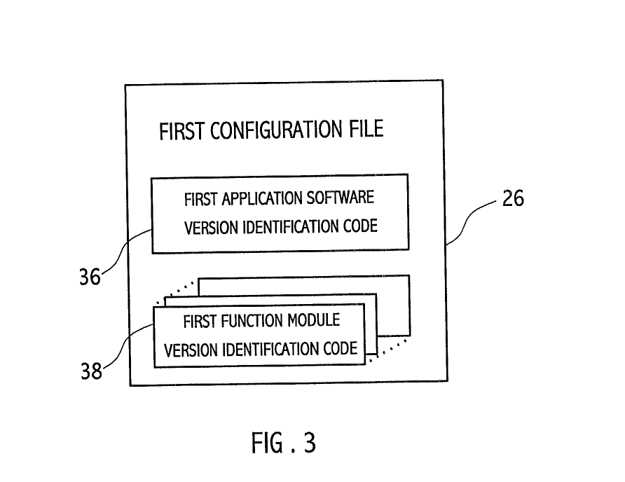

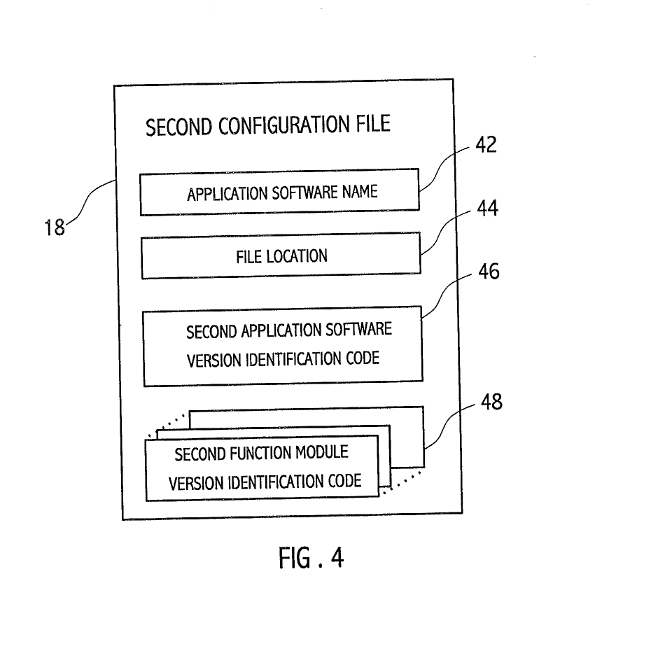

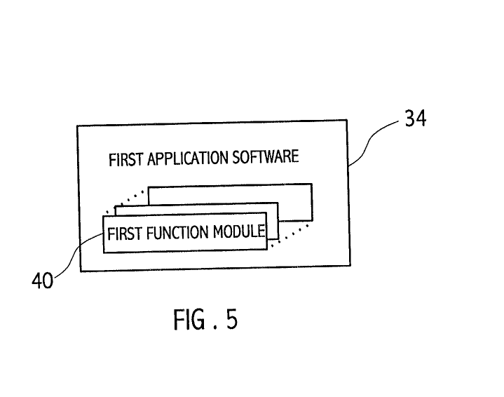

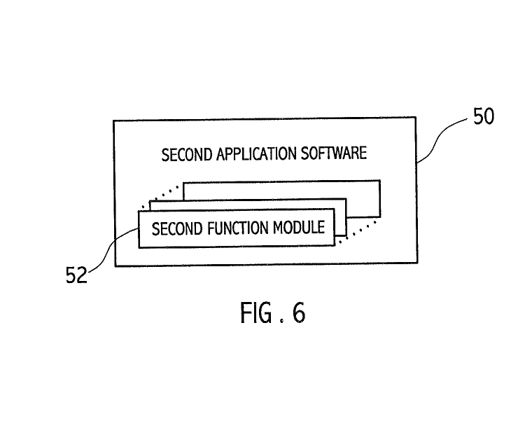

Referring to FIG. 1 to FIG. 6, FIG. 1 is a schematic view of a preferred system 10 in accordance with the present invention, FIGS. 2a and 2b show a flowchart of a preferred method 11 in accordance with the present invention, FIG. 3 is a schematic view of a first configuration file 26 of the system 10, FIG. 4 is a schematic view of a second configuration file 18 of the system 10, FIG. 5 is a schematic view of a first application software 34 of the system 10, and FIG. 6 is a schematic view of a second application software 50 of the system 10. As shown, the system includes a server 12, a client computer 14 and a plurality of external servers 16.

The server 12 includes a plurality of second configuration files 18 and a storage device 20. The client computer 14 includes a client storage device 22, a first configuration file 26 and a first application software 34. Each external server 16 includes a storage device 24.

The first configuration file 26 can be an independent file stored in the client computer 14 or can be stored in the registration file of the operation system.

Referring to FIG. 3, each of the first configuration files 26 has a first application software version identification code 36 and a plurality of first function module version identification codes 38. As shown in FIG. 5, the first application software 34 includes a plurality of first function module 40. The first application software version identification code 36 is respective to the first application software, and each of the first function module version identification codes 38 is respective to a first function module 40.

In addition, the client storage device 22 further has a first storage location 30 and a second storage location 32. The first function modules 40 can be divided into a first group and a second group. The first function modules 40 of the first group are stored in the first storage location 30, and on the other hand the first function modules 40 of the second group are stored in the second storage location 32.

As shown in FIG. 4, the second configuration file 18 includes an application software name 42, a file location 44, a second application software version identification code 46 and a plurality of second function module version identification codes 48. The file location 44 is respective to the storage device 20 or 24. The storage device 20 or 24 is used to store a second application software 50 respective to the application software name 42. As shown in FIG. 6, the second application software 50 includes a plurality of second function modules 52. The second application software version identification code 46 is respective to the second application software 50, and each of the second function module version identification codes 48 is respective to one of the second function modules 52.

Moreover, each of the first function modules 40 is respective to a second function module 52. In the present invention, the version identification code can be a version code or an updating time of the application software. The most recently-updated application software has the newest version.

Refer now to FIGS. 2a and 2b. In step 201, the client computer 14 executes the first application software and raises a request to the server 12.

In step 202, the server 12 accepts the request and sends out a second configuration file 18 to the client computer 14 in accordance with the request.

In step 203, the first application software 34 of the client computer 14 receives the second configuration file 18.

In step 204, the first application software 34 determines whether or not the second application software version identification code 46 is the same as the first application software version identification code 36. If yes, keep executing the first application software 34. If no, go to step 205.

In step 205, the first application software 34 determines whether or not the second function module version identification code 48 is the same as the respective first function module version identification code 38. If yes, go to step 206. If no, go to step 207.

In step 206, the first application software 34 determining whether or not any unprocessed second function module version identification code 48 exists. If yes, go to step 205 for determining the next second function module version identification code 48. If no, go to step 208.

In step 207, the first application software 34 utilizes the file location 44 of the second configuration file 18 to connect with the respective storage device 20 or 24 for downloading the second function module 52 respective to the second function module version identification code 48, and for further storing the second function module 52 into the client storage device 22. Then, go to step 206.

In steps 205 to 207, the first application software 34 can utilize the second function module version identification codes 48 to judge if each of the second function modules 52 is updated with respect to the corresponding first function module 40. Only in the case that the second function module 52 is judged to be an updated version, the first application module 34 processes the downloading. Therefore, the client computer 14 of the present invention does download only the updated second function modules 52, not all the second function modules 52.

In step 206, as soon as the first application software 34 finds that no more unprocessed second function module version identification code 48 is left, it implies that the first application software 34 has completed the downloading of all the updated second function modules 52. That is, all the updated second function modules 52 in the second application software 50 have been stored into the client storage device 22.

In step 208, the first function module 40 stored in the first storage location 30 duplicates the second function module 52 respective to the first function module 40 stored in the second storage location 32 to the second storage location 32 for replacing the respective first function module 40.

In step 209, the first function module 40 stored in the first storage location 30 starts the first function module 40 stored in the second storage location 32.

In step 210, the first function module 40 stored in the second storage location 32 can end the first function module 40 stored in the first storage location 30.

In another embodiment of step 210, the first function module 40 stored in the first storage location 30 can be ended by itself.

In step 211, the first function module 40 stored in the second storage location 32 duplicates the second function module 52 respective to the first function module 40 stored in the first storage location 30 to the first storage location 30 for replacing the respective first function module 40.

By providing the present invention, the system 10 can update the first application software 34 to the second application software 50, even though the system 10 is executing the first application software 34. After the updating, the second application software 50 can be used directly to continue the execution of the first application software 34 without any interruption throughout an executing job. Therefore, the system 10 of the present invention can perform an updating operation of the application software without bothering the user, so that a better application environment can be provided to the client computer 14.

Compared to the prior art, the system 10 of the present invention can update successfully an executing application software. As soon as the application software in the server is updated or changed, the user needn't terminate the execution of the old application software and can directly update the version of the executing application software. The present invention is particularly efficient with those small-scale software or with a wide-band network environment.

Therefore, in the system 10 of the present invention, the user can always work with the most updated version of the application software and can waive the notorious periodical upgrading operation upon the application software. For the users of the application software, always executing the newest version can be guaranteed by the automatic updating provided by the present invention. In addition, when the provider of the application software locates any bug in the software, the debugged application software can be provided in time to overwrite the old application software at the client computer end by utilizing the method of the present invention.

Further, another characteristics of the present invention is that the system 10 utilizes a module manner to update an executing application software. Before any download operation of the second function module 52, the system 10 can determine in advance whether the second function module 52 is an updated module or not. Only when the second function module 52 is an updated one, the client computer 14 needs to download the second function module 52. Therefore, the client computer 14 of the present invention can only download the updated second function modules 52, not all the second function modules 52, so that the efficiency upon updating the application software can be increased

While the present invention has been particularly shown and described with reference to a preferred embodiment, it will be understood by those skilled in the art that various changes in form and detail may be without departing from the spirit and scope of the present invention.

What is claimed is:

1. A method for updating an executing application software in a module manner, comprising:
a client computer executing a first application software and raising a request, the first application software including a plurality of first function modules, the client computer storing a first configuration file, the first configuration file further having a first application software version identification code respective to the first application software and a plurality of first function module version identification codes, each of the first function module version identification codes being respective to one of first function modules, the client computer further having a first storage location and a second storage location, the first function modules being divided into a first group and a second group, the first function modules of the first group being stored in the first storage location, and the first function modules of the second group being stored in the second storage location;
a server accepting the request and sending out a second configuration file to the client computer according to the request, the second configuration file having an application software name, a file location, a second application software version identification code and a plurality of second function module version identification codes, the file location being respective to a storage device, the storage device storing a second application software respective to the application software name, the second application software version identification code being respective to the second application software, the second application software including a plurality of second function modules, each of the second function module version identification codes being respective to a second function module, and each of the first function modules being respective to a second function module; and
the client computer executing following steps:
(a) the first application software receiving the second configuration file;
(b) the first application software determining whether or not the second application software version identification code is the same as the first application software version identification code; if yes, keeping executing the first application software; if no, going to step (c);
(c) the first application software determining whether or not the second function module version identification code is the same as the respective first function module version identification code; if yes, going to step (d); if no, going to step (e);
(d) the first application software determining whether or not any unprocessed second function module version identification code exists; if yes, going to step (c) for determining the next second function module version identification code; if no, going to step (f);
(e) the first application software following the file location of the second configuration file to connect the respective storage device for downloading and storing the second function module respective to the second function module version identification code; then, going to step (d);
(f) the first function module stored in the first storage location duplicating the second function module respective to the first function module stored in the second storage location to the second storage location for replacing the respective first function module;
(g) the first function module stored in the first storage location starting the first function module stored in the second storage location;
(h) ending the first function module stored in the first storage location; and
(i) the first function module stored in the second storage location duplicating the second function module respective to the first function module stored in the first storage location to the first storage location for replacing the respective first function module.

2. The method for updating an executing application software in a module manner according to claim 1, wherein said step (h) includes: said first function module stored in said first storage location ending by itself.

3. The method for updating an executing application software in a module manner according to claim 1, wherein said step (h) includes: said first function module stored in said second storage location ending said first function module stored in said first storage location.

4. The method for updating an executing application software in a module manner according to claim 1, wherein said storage device is an external server.

5. The method for updating an executing application software in a module manner according to claim 1, wherein said server includes said storage device.

6. The method for updating an executing application software in a module manner according to claim 1, wherein said client computer replaces said first configuration file with said second configuration file while said second application software version identification code is not the same as said first application software version identification code.

7. A system for updating an executing application software in a module manner, comprising:
a server, further including a plurality of second configuration files, each of the second configuration files having an application software name, a file location, a second application software version identification code and a plurality of second function module version identification codes, the file location being respective to a storage device, the storage device storing a second application software respective to the application software name, the second application software version identification code being respective to the second application software, the second application software including a plurality of second function modules, each of the second function module version identification codes being respective to one of the second function modules; and
a client computer, further including:
a first configuration file, stored in a client storage device, further having a first application software version identification code and a plurality of first function module version identification codes;
a first application software, being respective to the first application software version identification code, further including a plurality of first function modules, each of the first function modules being respective to one of the first function module version identification codes, and each of the first function modules being respective to one of the second function modules; and
the client storage device, further having a first storage location and a second storage location, the first function modules being divided into a first group and a second group, the first function modules of the first group being stored in the first storage location, and the first function modules of the second group being stored in the second storage location.

8. The system for updating an executing application software in a module manner according to claim 7, wherein said storage device is an external server.

9. The system for updating an executing application software in a module manner according to claim 7, wherein said server includes said storage device.

10. The system for updating an executing application software in a module manner according to claim 7, wherein said client computer replaces said first configuration file with said second configuration file while said second application software version identification code is not the same as said first application software version identification code.
